(19) United States
(12) Patent Application Publication
(10) Pub. No.: US 2016/0216029 A1
(43) Pub. Date: Jul. 28, 2016

(54) DEVICE FOR RECOVERING VAPOURS FROM A CRYOGENIC TANK

(71) Applicant: CRYOSTAR SAS, Hesingue (FR)

(72) Inventor: Mathias RAGOT, Sierentz (FR)

(21) Appl. No.: 14/917,366

(22) PCT Filed: Sep. 11, 2014
(86) PCT No.: PCT/FR2014/052258

§ 371 Date: Mar. 8, 2016

(30) Foreign Application Priority Data
Sep. 12, 2013 (GB) 1316227.6
Jun. 25, 2014 (FR) 1455931

(51) Int. Cl. F25J 1/00; F17C 13/08

(52) U.S. Cl. CPC F25J 1/0025; F17C 13/082; F17C 2221/033

(57) ABSTRACT

This device comprises: a compression unit (4) having a plurality of stages, said unit being supplied with gas from the cryogenic tank (2) and delivering gas at an engine supply pressure, a reliquefaction system (20) having an outlet for liquid to the cryogenic tank (2), and an exchanger (10) arranged between the cryogenic tank (2) and the compression unit (4), in order to heat the evaporation gas coming from the tank (2) before it enters the compression unit (4). The evaporation gas coming from the cryogenic tank (2) is heated by gas compressed inside the compression unit (4) to a pressure lower than the engine supply pressure. The reliquefaction system (20) is supplied with gas compressed inside the compression unit (4) to a pressure lower than the supply pressure of the engine.

The present invention relates to a device for recovering evaporation gas coming from a cryogenic tank.

The field of the present invention is, for example, the transport of cryogenic liquids. During transport, a cryogenic liquid is placed in a thermally insulated tank, but, in spite of the satisfactory thermal insulation implemented, heat exchanges between the interior of the tank and the exterior occur. These exchanges lead to an addition of energy from the exterior to the interior of the tank and lead to vaporization of a portion of the liquid in the tank. This vaporization tends to increase the pressure in the tank concerned. In order to limit this increase in pressure, the vaporized liquid is removed in gas form from the tank.

Depending on the nature of the cryogenic liquid (and thus of the corresponding gas) the evaporation gas collected in the tank can be processed in various ways. Thus, for example, one can consider simply discharging it into the atmosphere. The evaporation gas recovered can also be processed in order to be reliquefied and then reintroduced into the tank.

In the case in which the cryogenic liquid can be used as a fuel, for example, if it is LNG (English acronym for Liquid Natural Gas), then the recovered evaporation gas can be used for the driving the transport vehicle, in general a ship (methane tanker).

The present invention relates here more particularly to a system for recovering gas from evaporation of cryogenic liquid, which makes it possible, depending on the needs, to supply a high-pressure gas engine and/or to reliquefy this recovered evaporation gas. For supplying an engine that runs on natural gas, a medium/high pressure compressor is generally provided, which brings the natural gas to pressures on the order of 10 to 300 bar (that is to say 1 to 30 MPa). Depending on the speed of the ship, the gas demands of the engine vary and all or part of the evaporation gas recovered is compressed in order to supply the engine, or it is sent to a device for the reliquefaction thereof.

The evaporation gas which goes to a reliquefaction device is conventionally at a pressure of at least 4 bar (or 0.4 MPa) and at a temperature of approximately −100 to +40° C. As mentioned above, after reliquefaction, the liquid obtained returns to the cryogenic liquid tank.

The document WO-2007/117148 illustrates a method and an apparatus making it possible to preheat a stream of evaporated liquefied natural gas coming from a tank of a reliquefaction system before its compression. The method consists in having the evaporation gas stream undergo a heat exchange in a first heat exchanger with a stream of a second cooling stream having a higher temperature than the evaporation gas stream, the second cooling stream being obtained by a selective partitioning of a first cooling stream into this second cooling stream and a third cooling stream, the latter being injected into a first cooling passage of a cold box of the reliquefaction system. The evaporation gas thus reaches near-ambient temperatures before its compression, and the cold originating from the evaporation gas is substantially transferred to the reliquefaction system. Before the compression step, in order to preheat the evaporation gas to near-ambient temperatures, the cold evaporation gas undergoes a heat exchange with the cooling stream which is at a temperature that is higher than that of the evaporation gas before the heat exchange.

The aim of the present invention is therefore to provide a device for recovering evaporation gas of a cryogenic liquid that is used to supply, on the one hand, a compression unit for an engine, and, on the other hand, a reliquefaction system, said device for recovering evaporation gas having a reduced power consumption.

Advantageously, the proposed device will make it possible to entirely prevent contamination of the gas that supplies the compression unit and is intended for an engine. Preferably, this device has a simple design and low production cost.

To this effect, the present invention proposes a device for recovering evaporation gas coming from a cryogenic tank, comprising:

a compression unit having several compression stages, said unit being supplied with gas from the cryogenic tank and delivering gas at an engine supply pressure,

a reliquefaction system having an outlet for liquid to the cryogenic tank,

an exchanger arranged between the cryogenic tank and the compression unit, in order to cool the gas before it enters the liquefaction system and thereby heat the evaporation gas coming from the tank before it enters the compression unit.

According to the invention, the evaporation gas coming from the cryogenic tank is heated by gas compressed inside the compression unit to a pressure less than or equal to the engine supply pressure, and the reliquefaction system is supplied with gas compressed inside the compression unit to a pressure less than or equal to the supply pressure of the engine, optionally cooled by the evaporation gas supplying the compression unit.

This configuration is found to be particularly advantageous in terms of power consumption. In a highly original manner, when the technology of the compression unit permits, a portion of the compressed evaporation gas can be removed before it reaches its setpoint pressure (corresponding to the supply pressure of the engine) in order to supply the reliquefaction system. In addition, this compressed gas is cooled by the evaporation gas supplying the compression unit. This is advantageous, on the one hand, because it is preferable to heat the evaporation gas before it enters the compression unit, and, on the other hand, it is also preferable to cool the gas that enters the reliquefaction system.

In order to improve the control of the pressure and of the temperature at the inlet of the reliquefaction system, it is proposed that the device for recovering evaporation gas be such that the compression unit comprises an inlet, a first outlet at the engine supply pressure, and a second outlet at an intermediate pressure, and that the second outlet be connected, on the one hand, to the exchanger, and, on the other hand, to a three-way valve, said three-way valve having an inlet that is directly connected to the second outlet, an inlet supplied with gas coming from the second outlet after its passage in the exchanger, and an outlet to the reliquefaction system.

In order to make it possible to lower the pressure (and the temperature) before the entry into the liquefaction system, an expansion valve is advantageously arranged upstream of the reliquefaction system. When the device is also equipped with a three-way valve, the expansion valve can be downstream of the unit formed by the exchanger and the three-way valve, but it is preferably upstream of this unit in order to limit the risk of having liquid inside the exchanger.

In order to limit the risks of contamination of the evaporation gas which is subsequently reliquefied, it is advantageously provided that the compression unit is non-lubricated. Otherwise, this compression unit comprises advantageously at least one non-lubricated compression stage upstream of at least one lubricated compression stage. An outlet at an intermediate pressure upstream of the lubricated compression stages can then be considered. It is also possible to consider the installation of a unit for processing the gas (for example, a coalescing filter or an activated charcoal filter) in order to avoid, or at least limit, the entrainment of oil towards the reliquefaction system.

In an embodiment, the device for recovering evaporation gas according to any one of claims 1 to 4, characterized in that the reliquefaction system comprises a closed loop of refrigerant fluid supplying at least one heat exchanger for cooling the evaporation gas entering the reliquefaction system.

In this embodiment, a single exchanger can be used to implement, on the one hand, the heating of the evaporation gas coming from the tank before it enters the compression unit, and, on the other hand, the cooling of the evaporation gas entering the reliquefaction system using the closed loop of refrigerant fluid.

When a closed loop of refrigerant fluid is provided, the loop contains essentially nitrogen, for example.

The present invention also relates to:

a unit comprising at least one cryogenic tank, an engine using medium- or high-pressure natural gas as fuel, and a device for recovering evaporation gas coming from said cryogenic tanks, characterized in that the device for recovering evaporation gas is a device for recovering evaporation gas as described above, and

a ship for the transport of liquefied natural gas, characterized in that it comprises a device for recovering evaporation gas, as described above.

Details and advantages of the present invention will become more apparent in the following description provided in reference to the appended diagrammatic drawing in which:

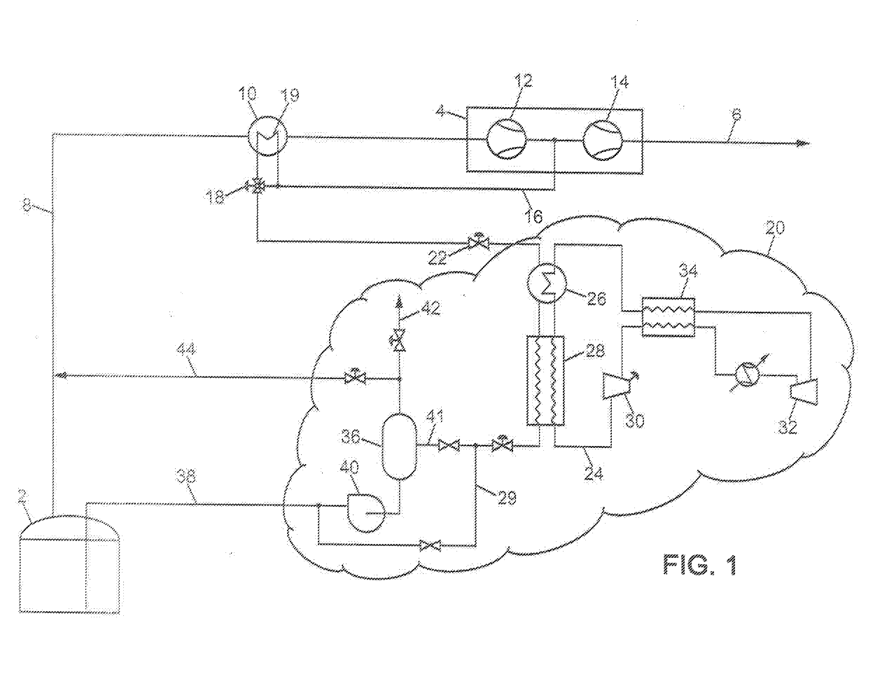

FIG. 1 diagrammatically illustrates a first embodiment of a device for recovering evaporation gas coming from a cryogenic tank,

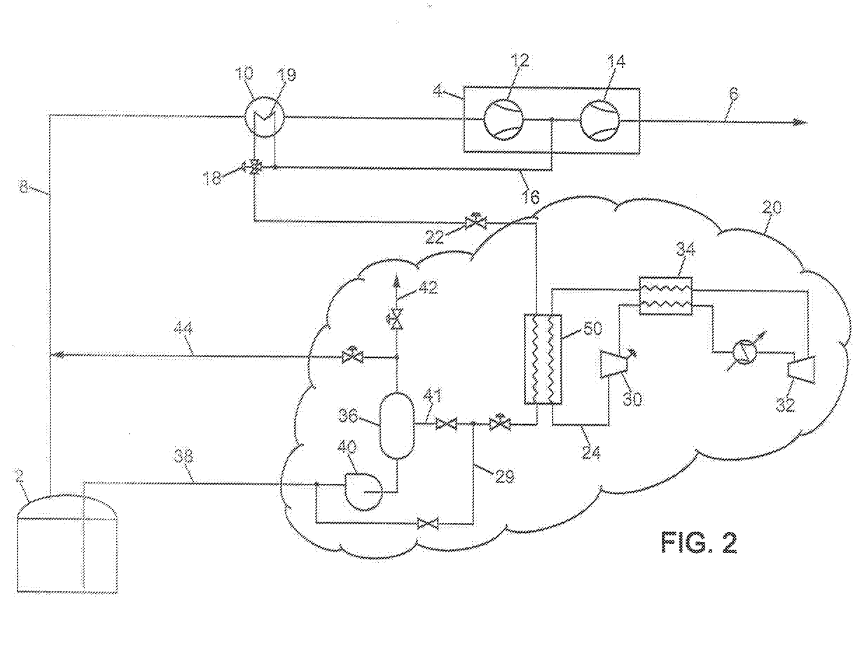

FIG. 2 is a view similar to that of FIG. 1 for a first embodiment variant, and

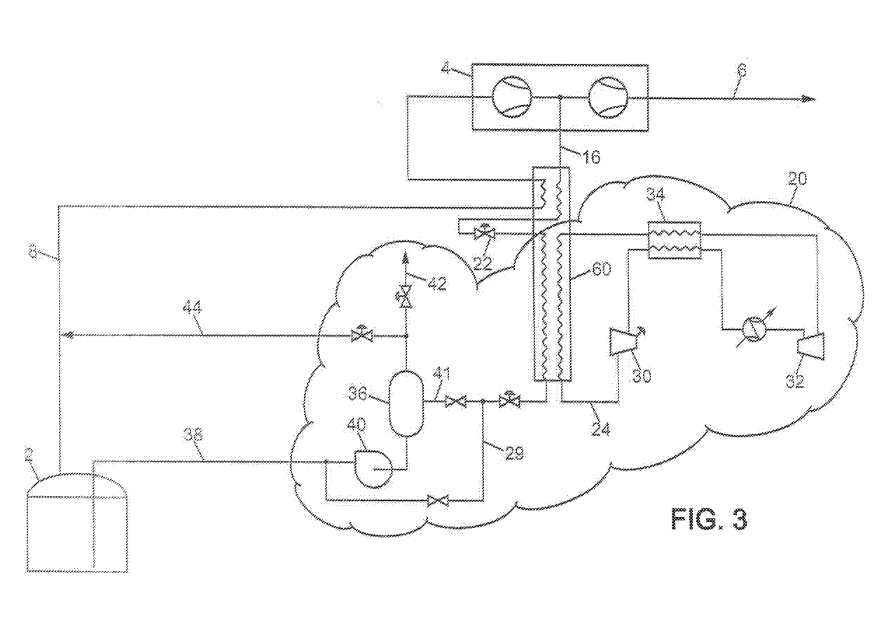

FIG. 3 is a view similar to those of FIGS. 1 and 2 of a second embodiment variant.

The following description is made in reference to a ship having at least one cryogenic liquid tank 2 on-board. Usually, on a ship there are several tanks, or there is one tank that is partitioned in particular to avoid pitching problems. A single tank will be considered here, but it is clear to the person skilled in the art that the teaching of this document applies to several tanks. Below, it is assumed that LNG is used (English acronym for Liquid Natural Gas), that is to say liquefied natural gas. The ship then comprises at least one engine (not shown) that runs on compressed natural gas as fuel.

In order to supply the engine with compressed natural gas, gas from evaporation of LNG is recovered in the tank 2, compressed in a compression unit 4 in order to be sent by a supply line 6 to the engine where it is then used as fuel. This evaporation gas is commonly referred to by the English acronym BOG (for Boil Off Gas). It comes from the heat exchanges that are inevitable, regardless of the insulation of the tank 2 that occur between the LNG, stored at temperatures which are in general on the order of −160° C., and the exterior.

A pipe 8 for evaporation gas thus connects an upper portion of the tank 2 to an inlet of the compression unit 4. An exchanger 10 is arranged on this pipe upstream of the compression unit 4. Here, it makes it possible to heat the cold evaporation gas coming from the tank 2 before it is introduced into the compression unit 4.

The compression unit 4 generally comprises several compression stages, since it is appropriate to have a supply pressure for the engine that, depending on the engine, is generally between 10 and 300 bar (or between 1 and 30 MPa). The first compression stages are represented diagrammatically by a first stage 12, while the last stages are represented diagrammatically in the figures only by a second stage 14. The supply line 6 is connected to the outlet of the second stage 14 in the configurations illustrated in the drawing. Conventionally, a cooling of the gas can be provided after each stage of the compression unit. The corresponding exchangers, conventionally referred to as “intercoolers” or “aftercoolers,” are not depicted in the drawing.

In the embodiments illustrated, the compression unit 4 has an intermediate outlet delivering evaporation gas at an intermediate pressure lower than the supply pressure of the engine, upstream of the second stage 14. Preferably, in order to prevent any risk of contamination of the gas that is going to be liquefied, when the compression unit 4 has lubricated compression stages and nonlubricated compression stages, this intermediate outlet is placed upstream of the lubricated compression stages, that is to say before the evaporation gas risks potentially coming in contact with lubricant.

The intermediate outlet then supplies a pipe 16 which extends from the compression unit 4 and, more precisely, from its intermediate outlet, to a three-way valve 18. An inlet of the three-way valve 18 is supplied directly by the pipe 16 from the intermediate outlet of the compression unit 4. Upstream of the three-way valve 18, this pipe 16 has a bypass which forms a branch 19. The latter thus starts from the pipe 16, supplies the exchanger 10 countercurrently with respect to the cold evaporation gas coming from the tank 2 in order to heat it, and then it ends with a connection to a second inlet of the three-way valve 18. An outlet of the three-way valve 18 then supplies a reliquefaction system 20. Preferably, a valve 22 is provided downstream of the three-way valve 18 and upstream of the reliquefaction system 20. However, it is also possible to consider arranging the valve 22 upstream of the three-way valve 18, that is to say on the pipe 16, directly at the intermediate outlet of the compression unit 4, for example. This valve 22, in its different positions, makes it possible to adjust the pressure of the evaporation gas entering the reliquefaction system 20 by reducing it. During this reduction of the pressure of the evaporation gas, the temperature of the latter also decreases.

The reliquefaction system 20 is of a type known to the person skilled in the art. It operates, for example, according to the Brayton cycle, and comprises a closed nitrogen loop 24. The latter comprises conventionally a first exchanger 26 and a second exchanger 28 enabling a heat exchange between the nitrogen and the evaporation gas, a turbine 30, a compressor 32 and a third exchanger 34 for bringing about a heat exchange in the nitrogen of the closed nitrogen loop 24.

The evaporation gas cooled and liquefied inside the first exchanger 26 and inside the second exchanger 28 is generally sent directly back to the tank 2 by means of a line 29. When the evaporation gas contains a large quantity of inert gas (primarily nitrogen), it is advantageous to liquefy it and to send it through a line 41 so that it flows inside a separator 36 operating at a pressure that can be slightly lower than the pressure inside the reliquefaction unit 20. The lower portion of the separator has an outlet which makes it possible to supply a return line 38 to the tank 2, possibly by means of a pump 40. The upper portion of the separator 36 allows the inert gases to be evacuated by means of a venting pipe 42 controlled by a valve, or to rejoin the evaporation gas coming directly from the tank 2 by being reinjected through an injection line 44 into the pipe 8.

The embodiment variant of FIG. 2 provides only one exchanger 50 instead of the first exchanger 26 and of the second exchanger 28 of the reliquefaction system 20 of FIG. 1.

In FIG. 3, inside the same exchanger 60, on the one hand, the exchanges between the evaporation gas coming directly from the tank 2 and the evaporation gas compressed to an intermediate pressure, and, on the other hand, the exchanges inside the reliquefaction system between the refrigerant fluid (nitrogen) and the evaporation gas to be liquefied, are implemented. In this embodiment variant, it is provided to run the entire stream flowing through the pipe 16 coming from the intermediate outlet of the compression unit 4 into the exchanger 60. The embodiment represented thus comprises no three-way valve, but it is apparent to the person skilled in the art that such a valve could also be provided in this embodiment.

In a ship that transports cryogenic liquid, the quantity of evaporation gas resulting from the heat exchanges between the tank(s) and the exterior is substantially constant. On the other hand, the consumption of the engines varies. The quantity of evaporation gas that is not used by the engines is then preferably reliquefied. The devices for recovering evaporation gas that are described above make it possible to adapt the production of high-pressure gas for the supplying of the engines and for the reliquefaction of the evaporation gas that is not used by the engine(s).

It is proposed here to “extract” a quantity of evaporation gas at an intermediate pressure in a compression unit supplying the engine(s). The heat exchange implemented between the evaporation gas coming directly from the tank and the evaporation gas at an intermediate pressure makes it possible to optimize the power consumption of the device for recovering evaporation gas. In the embodiment illustrated, an expansion valve 22 is used, that is located upstream or downstream of the heat exchange in order to optimize the pressure conditions under which the evaporation gas enters re-enters the reliquefaction system 20. Depending on the properties of the evaporation gas at intermediate pressure, the possible presence of a three-way valve makes it possible to better control the temperature of the evaporation gas before it enters the reliquefaction system.

The variants illustrated above thus make possible an optimization of the power consumption, on the one hand, for compressing the evaporation gas and supplying the engine(s), and, on the other hand, for reliquifying the evaporation gas that is not used by the engine(s).

As illustrated in the embodiment variants, the construction is relatively modular and it is possible to limit the number of exchangers needed. The solutions proposed here thus make possible an adaptation to various configurations encountered on board a ship or at the site of the installation for recovering LNG or another cryogenic liquid.

The present invention is not limited to the embodiments described above and to other variants mentioned. It also relates to any embodiment within the reach of the person skilled in the art in the context of the following claims.

1. A device for recovering vapors from a cryogenic tank (2), comprising:
a compression unit (4) having several compression stages, said unit being supplied with gas from the cryogenic tank (2) and delivering gas at an engine supply pressure,
a reliquefaction system (20) having an outlet for liquid to the cryogenic tank (2),
an exchanger (10) arranged between the cryogenic tank (2) and the compression unit (4), in order to cool the gas before it enters the liquefaction system and thereby heat the evaporation gas coming from the tank (2) before it enters the compression unit (4),
characterized in that the evaporation gas coming from the cryogenic tank (2) is heated by gas compressed inside the compression unit (4) to a pressure lower than or equal to the engine supply pressure, and in that the reliquefaction system (20) is supplied with gas compressed inside the compression unit (4) to a pressure less than the supply pressure of the engine, optionally cooled by the evaporation gas supplying the compression unit (4).

2. The device for recovering evaporation gas according to claim 1, characterized in that the compression unit (4) comprises an inlet, a first outlet at the engine supply pressure, and a second outlet at an intermediate pressure, in that the second outlet is connected, on the one hand, to the exchanger (10), and, on the other hand, to a three-way valve (18), said three-way valve (18) having an inlet that is directly connected to the second outlet, an inlet supplied with gas coming from the second outlet after its passage in the exchanger (10), and an outlet to the reliquefaction system (20).

3. The device for recovering evaporation gas according to claim 1, characterized in that an expansion valve (22) is arranged upstream of the reliquefaction system (20).

4. The device for recovering evaporation gas according to claim 2, characterized in that the expansion valve (22) is arranged downstream of a unit formed by the exchanger (10) and the three-way valve (18).

5. The device for recovering evaporation gas according to claim 1, characterized in that the reliquefaction system (20) comprises a closed loop (24) of refrigerant fluid supplying at least one heat exchanger (26, 28; 50; 60) for cooling the evaporation gas entering the reliquefaction system (20).

6. The device for recovering evaporation gas according to claim 5, characterized in that a single exchanger (60) is used to implement, on the one hand, the heating of evaporation gas coming from the tank (2) before it enters the compression unit (4), and, on the other hand, the coding of the evaporation gas entering the reliquefaction system (20) through the dosed loop (24) of refrigerant fluid.

7. The device for recovering evaporation gas according to claim 5, characterized in that the dosed loop (24) of refrigerant fluid contains essentially nitrogen.

8. A unit comprising at least one cryogenic tank, an engine using high-pressure natural gas as fuel and a device for recovering evaporation gas coming from said cryogenic tanks, characterized in that the device for recovering evaporation gas is a device for recovering evaporation gas according to claim 1.

9. A ship for transporting liquefied natural gas, characterized in that it comprises a device for recovering evaporation gas according to claim 1.
